(19) United States
(12) Patent Application Publication
(10) Pub. No.: US 2026/0318576 A1
(43) Pub. Date: Oct. 15, 2026

(54) AIR CONDITIONER AND CONTROL METHOD

(71) Applicant: Mitsubishi Electric Corporation, Tokyo (JP)

(72) Inventors: Takehiro KOYANO, Tokyo (JP); Yu OTORII, Tokyo (JP)

(21) Appl. No.: 19/484,443

(22) PCT Filed: Aug. 24, 2023
(86) PCT No.: PCT/JP2023/030436

§ 371 Date: Nov. 14, 2025

(51) Int. Cl. F25B 49/00; F25B 41/24; F25B 49/02; G01M 3/04

(52) U.S. Cl. CPC F25B 49/005; F25B 41/24; F25B 49/022; G01M 3/04

(57) ABSTRACT

An air conditioner includes: a plurality of utilization-side units each having a utilization-side heat exchanger that supplies cold heat or hot heat to an air conditioning target space by heat exchange of a refrigerant; a heat source-side unit including a compressor configured to compress the refrigerant; a refrigerant sensor that detects the refrigerant that has leaked into the air conditioning target space; and a countermeasure processing unit that executes safety countermeasure processing against leakage of the refrigerant detected by the refrigerant sensor and, in a case where abnormality has occurred in communication with a countermeasure-related unit related to the safety countermeasure processing, configured to restrict an operation of a utilization-side unit corresponding to the countermeasure-related unit in which the communication abnormality has occurred, among the plurality of utilization-side units, while maintaining an operation of the compressor by the heat source-side unit.

### TECHNICAL FIELD

The present disclosure relates to an air conditioner and a control method.

### BACKGROUND ART

In recent years, in an air conditioner using a combustible refrigerant, a technology for ensuring safety, such as operating a ventilation device in response to refrigerant leakage, is known (refer to, for example, Patent Document 1).

In addition, in such an air conditioner of the related art, for example, in a case where there is a possibility that safety countermeasures do not normally operate, such as occurrence of communication abnormality between devices, it is known to prohibit the operation of the air conditioner.

### CITATION LIST

### Patent Document

Patent Document 1: Japanese Unexamined Patent Application, First Publication No. 2016-211762

### SUMMARY OF INVENTION

### Technical Problem

However, in the air conditioner of the related art, for example, in a case where a plurality of indoor units are connected to one outdoor unit, when abnormality has occurred in communication with a specific indoor unit, the operation of the air conditioner is prohibited, and the outdoor unit in which communication abnormality has not occurred also cannot be used, which may impair convenience to the user.

The present disclosure has been made in order to solve the above-described problem, and an object of the present disclosure is to provide an air conditioner and a control method, in which it is possible to obtain high convenience while ensuring safety.

### Solution to Problem

In order to solve the above problem, an aspect of the present disclosure is an air conditioner including: a plurality of utilization-side units each having a utilization-side heat exchanger configured to supply cold heat or hot heat to an air conditioning target space by heat exchange of a refrigerant; a heat source-side unit including a compressor configured to compress the refrigerant; a refrigerant sensor configured to detect the refrigerant that has leaked into the air conditioning target space; and a countermeasure processing unit configured to execute safety countermeasure processing against leakage of the refrigerant detected by the refrigerant sensor and, in a case where abnormality has occurred in communication with a countermeasure-related unit related to the safety countermeasure processing, configured to restrict an operation of a utilization-side unit corresponding to the countermeasure-related unit in which communication abnormality has occurred, among the plurality of utilization-side units, while maintaining an operation of the compressor by the heat source-side unit.

In addition, an aspect of the present disclosure is a control method of an air conditioner including a plurality of utilization-side units each having a utilization-side heat exchanger configured to supply cold heat or hot heat to an air conditioning target space by heat exchange of a refrigerant, a heat source-side unit including a compressor configured to compress the refrigerant, and a refrigerant sensor configured to detect the refrigerant that has leaked into the air conditioning target space, the control method including:
a countermeasure processing unit executing safety countermeasure processing against leakage of the refrigerant detected by the refrigerant sensor and, in a case where abnormality has occurred in communication with a countermeasure-related unit related to the safety countermeasure processing, the countermeasure processing unit restricting an operation of a utilization-side unit corresponding to the countermeasure-related unit in which communication abnormality has occurred, among the plurality of utilization-side units, while maintaining an operation of the compressor by the heat source-side unit.

### Advantageous Effects of Invention

According to the present disclosure, it is possible to obtain high convenience while ensuring safety.

### BRIEF DESCRIPTION OF DRAWINGS

FIG. 1 A configuration diagram showing an example of an air conditioning system according to a first embodiment.

FIG. 2 A functional block diagram showing an example of the air conditioning system according to the first embodiment.

FIG. 3 A flowchart showing an example of safety countermeasure processing of the air conditioning system according to the first embodiment.

FIG. 4 A flowchart showing an example of restriction processing in a case where communication abnormality has occurred in the air conditioning system according to the first embodiment.

FIG. 5 A configuration diagram showing an example of an air conditioning system according to a second embodiment.

FIG. 6 A functional block diagram showing an example of the air conditioning system according to the second embodiment.

FIG. 7 A flowchart showing an example of restriction processing in a case where communication abnormality has occurred in the air conditioning system according to the second embodiment.

FIG. 8 A diagram explaining an example of a hardware configuration of each control device of the air conditioning system of the present disclosure.

### DESCRIPTION OF EMBODIMENTS

Hereinafter, an air conditioner and a control method according to an embodiment of the present disclosure will be described with reference to the drawings.

### First Embodiment

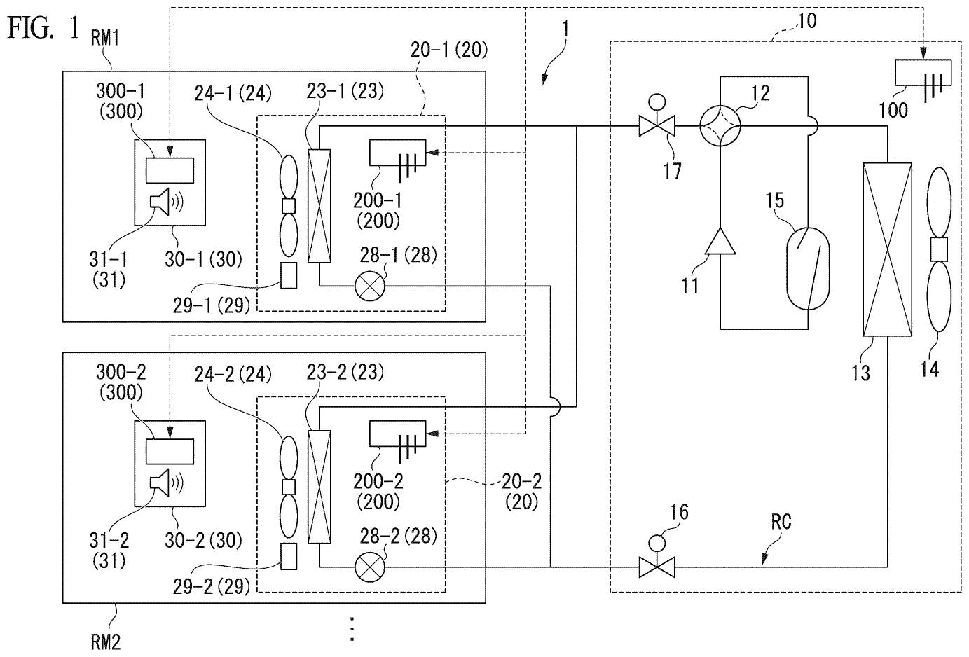

FIG. 1 is a configuration diagram showing an example of an air conditioning system 1 according to a first embodiment.

As shown in FIG. 1, the air conditioning system 1 includes an outdoor unit 10, a plurality of indoor units 20 (20-1 and 20-2), and a plurality of external controllers 30 (30-1 and 30-2).

The air conditioning system 1 is installed in, for example, a single-family house, a mansion, an office building, or the like, and executes a cooling operation or a heating operation by performing a refrigerant cycle operation that circulates a refrigerant using a vapor compression type, thereby processing a selected cooling command (cooling ON/OFF) or heating command (heating ON/OFF) in the indoor unit 20.

In the present embodiment, the air conditioning system 1 is an example of an air conditioner.

In addition, in the present embodiment, the indoor unit 20-1 and the indoor unit 20-2 have the same configuration, and in a case where any indoor unit included in the air conditioning system 1 is indicated or not distinguished, the indoor unit 20-1 and the indoor unit 20-2 will be described as the indoor unit 20.

In addition, the external controller 30-1 and the external controller 30-2 have the same configuration, and in a case where any external controller included in the air conditioning system 1 is indicated or not distinguished, the external controller 30-1 and the external controller 30-2 will be described as the external controller 30.

The outdoor unit 10 is a heat source unit that generates heat to be supplied to the indoor unit 20, and functions as a heat source-side unit. The outdoor unit 10 includes a compressor 11, a four-way valve 12, an outdoor heat exchanger 13, an outdoor fan 14, a pressure vessel 15, a liquid pipe shut-off valve 16, a gas pipe shut-off valve 17, and an outdoor unit control device 100.

The compressor 11 is a device that compresses a refrigerant, and has a variable operating capacity. The compressor 11 sucks in the refrigerant and compresses the refrigerant to a high-temperature and high-pressure state. The refrigerant circulates between the outdoor unit 10 and the indoor unit 20 to perform heat exchange through a refrigerant circuit RC. The refrigerant is, for example, a combustible refrigerant.

The four-way valve 12 is a valve for switching directions of a flow of the refrigerant, and has first to fourth ports. The first port is connected to a discharge side of the compressor 11, and the second port is connected to the outdoor heat exchanger 13. In addition, the third port is connected to the suction side of the compressor 11, and the fourth port is connected to the indoor unit 20.

The four-way valve 12 is configured such that setting is switchable between a state where the first port and the second port communicate with each other and the third port and the fourth port are closed (a state shown by a solid line in FIG. 1) and a state where the third port and the fourth port communicate with each other and the first port and the second port are closed (a state shown by a broken line in FIG. 1).

In the four-way valve 12, the state shown by a solid line in FIG. 1 is a connection in a cooling operation direction, and the state shown by a broken line in FIG. 1 is a connection in a heating operation direction.

The outdoor heat exchanger 13 is, for example, a cross fin type fin-and-tube type heat exchanger composed of a heat transfer tube and a large number of fins, and performs heat exchange between the outside air and the refrigerant to discharge heat.

The outdoor fan 14 is, for example, a propeller fan, and is a blowing device that blows air to the outdoor heat exchanger 13. The rotation speed of the outdoor fan 14 is changeable.

The pressure vessel 15 secures a surplus refrigerant in the vessel and suppresses a liquid refrigerant from flowing into the compressor 11.

The liquid pipe shut-off valve 16 is disposed between the outdoor heat exchanger 13 and the indoor unit 20 on the refrigerant circuit RC, and is an example of a shut-off valve.

The gas pipe shut-off valve 17 is disposed between the four-way valve 102 and the indoor unit 20 on the refrigerant circuit RC, and is an example of a shut-off valve.

These shut-off valves suppress the refrigerant from flowing from the outdoor unit 10 to the indoor unit 20 in a case where the refrigerant leaks from the indoor unit 20, The outdoor unit control device 100 is configured with, for example, a processor including a central processing unit (CPU), and the like, and controls the outdoor unit 10. The outdoor unit control device 100 is an example of a heat source-side control unit. The outdoor unit control device 100 controls each part of the outdoor unit 10 and can communicate with each of the indoor unit 20 and the external controller 30. Details of the outdoor unit control device 100 will be described later.

The indoor unit 20 is an example of a utilization-side unit that supplies cold heat or hot heat to an air conditioning target space by heat exchange of the refrigerant. The indoor unit 20 and the outdoor unit 10 are connected to each other by a refrigerant pipe. The air conditioning target space is, for example, a space such as a room of a user, and corresponds to a room RM1 and a room RM2 in the example shown in FIG. 1.

In the present embodiment, the indoor unit 20-1 and the external controller 30-1 will be described as being installed in the room RM1 and the indoor unit 20-2 and the external controller 30-2 will be described as being installed in the room RM2.

The indoor unit 20 includes an indoor heat exchanger 23, an indoor fan 24, a pressure reduction mechanism 28, a refrigerant sensor 29, and an indoor unit control device 200. It should be noted that, in the description, the reference numerals of the respective configurations of the indoor unit 20-1 corresponding to the room RM1 are added with “−1”, and the reference numerals of the respective configurations of the indoor unit 20-2 corresponding to the room RM2 are added with “−2”.

The indoor heat exchanger 23 is an example of a utilization-side heat exchanger that supplies cold heat or hot heat to the air conditioning target space by heat exchange of the refrigerant. The indoor heat exchanger 23 is, for example, a cross fin type fin-and-tube type heat exchanger composed of a heat transfer tube and a large number of fins. The indoor heat exchanger 23 is disposed on the refrigerant circuit RC and performs heat exchange between indoor air and the refrigerant.

The indoor fan 24 is, for example, a sirocco fan or the like, and is a blowing device that blows air to the indoor heat exchanger 23. The rotation speed of the indoor fan 24 is changeable.

The pressure reduction mechanism 28 is disposed on the refrigerant circuit RC and decompresses and expands the refrigerant.

The refrigerant sensor 29 is installed, for example, in the indoor unit 20 and detects a refrigerant that leaks into the air conditioning target space.

The indoor unit control device 200 is configured with, for example, a processor including a CPU, and the like, and controls the indoor unit 20. The indoor unit control device 200 is an example of a utilization-side control unit. The indoor unit control device 200 controls each part of the indoor unit 20 and can communicate with each of the outdoor unit 10 and the external controller 30. Details of the indoor unit control device 200 will be described later.

The external controller 30 is, for example, a remote controller, and includes an interface through which a user can make a control request to the air conditioning system 1. In addition, for example, in a case where the refrigerant sensor 29 included in the indoor unit 20 detects refrigerant leakage, the external controller 30 can notify the user of the occurrence of refrigerant leakage by outputting an alarm (warning).

The external controller 30 includes an alarm output unit 31 and a controller control device 300. It should be noted that, in the description, the reference numerals of the respective configurations of the external controller 30-1 corresponding to the room RM1 are added with “−1”, and the reference numerals of the respective configurations of the external controller 30-2 corresponding to the room RM2 are added with “−2”.

The alarm output unit 31 is, for example, a speaker, and outputs (emits) an alarm (warning) that notifies that the refrigerant leakage has occurred.

The controller control device 300 is configured with, for example, a processor including a CPU, and the like, and controls the external controller 30. The controller control device 300 is an example of an external controller control unit. The controller control device 300 controls each unit of the external controller 30 and can communicate with each of the outdoor unit 10 and the indoor unit 20. Details of the controller control device 300 will be described later.

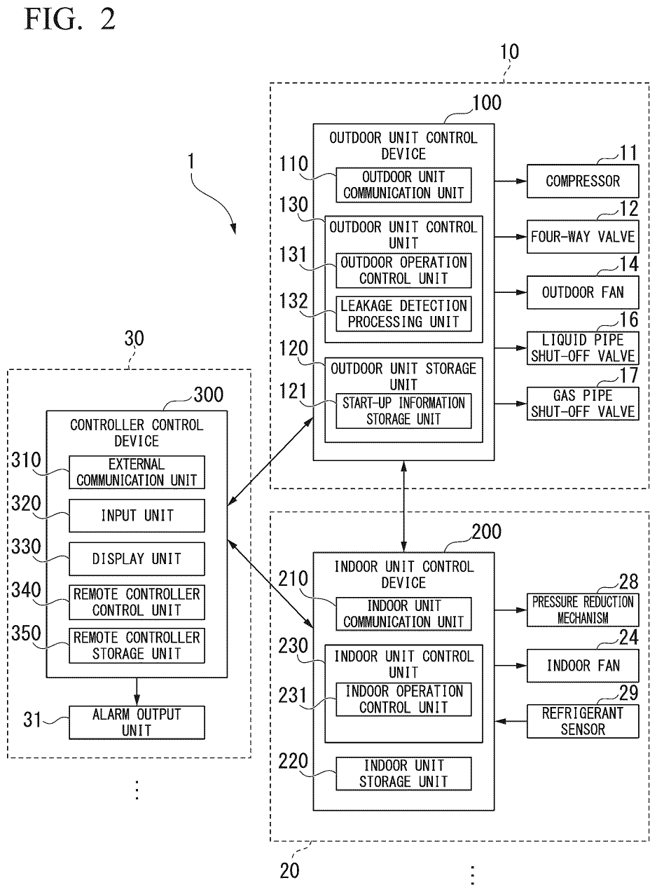

Next, a functional block of the air conditioning system 1 according to the present embodiment will be described with reference to FIG. 2.

FIG. 2 is a functional block diagram showing an example of the air conditioning system 1 according to the present embodiment.

As shown in FIG. 2, the air conditioning system 1 includes the outdoor unit control device 100, the indoor unit control device 200, and the controller control device 300.

The outdoor unit control device 100, the indoor unit control device 200, and the controller control device 300 are capable of notifying each other.

The indoor unit control device 200 is disposed in, for example, the indoor unit 20 and controls the indoor fan 24 and the pressure reduction mechanism 28. In addition, the indoor unit control device 200 acquires detection information of the refrigerant sensor 29.

The indoor unit control device 200 includes an indoor unit communication unit 210, an indoor unit storage unit 220, and an indoor unit control unit 230.

The indoor unit communication unit 210 is a communication unit that can input communication data information and output the communication data information to the outside by communication means such as a telephone line, a LAN line, or wireless communication, for example.

The indoor unit storage unit 220 is configured with, for example, a semiconductor memory, and stores various types of information for controlling the indoor unit 20.

The indoor unit control unit 230 is, for example, a functional unit that is implemented by causing a CPU (not shown) to execute a control program, and executes various types of processing of controlling the indoor unit 20. The indoor unit control unit 230 acquires, for example, detection information of the refrigerant sensor 29 to detect refrigerant leakage.

The indoor unit control unit 230 includes an indoor operation control unit 231. The indoor operation control unit 231 controls the operation of the indoor unit 20, such as a cooling operation or a heating operation.

The controller control device 300 is disposed in, for example, the external controller 30, and controls the alarm output unit 31. In addition, the controller control device 300 receives operation information about the air conditioning system 1 from the user, and transmits various operation commands such as a cooling command (cooling ON/OFF) or a heating command (heating ON/OFF) to the outdoor unit 10 or the indoor unit 20. In addition, in a case where the refrigerant leakage occurs, the controller control device 300 outputs an alarm (warning) by the alarm output unit 31.

The controller control device 300 includes an external communication unit 310, an input unit 320, a display unit 330, a remote controller control unit 340, and a remote controller storage unit 350.

The external communication unit 310 is a communication unit that can input communication data information and output the communication data information to the outside by communication means such as a telephone line, a LAN line, or wireless communication, for example.

The input unit 320 is an input device such as an operation button or a touch panel, for example. The input unit 320 receives various operation commands of the air conditioning system 1 according to the operation of the user.

The display unit 330 is a display device such as a liquid crystal display, for example. The display unit 330 displays, for example, an operating state of the air conditioning system 1. In a case where the refrigerant sensor 29 detects the refrigerant leakage, the display unit 330 displays, for example, a display for prompting ventilation of the air conditioning target space or information for prompting retreat from the air conditioning target space.

The remote controller control unit 340 is a functional unit that is implemented by causing a CPU (not shown) to execute a control program, and executes various types of processing of controlling the external controller 30. The remote controller control unit 340 executes, for example, controls of receiving various operation commands from the input unit 3210, transmitting various operation commands via the external communication unit 310, displaying the operating state on the display unit 330, outputting an alarm to the alarm output unit 31, and the like.

The remote controller storage unit 350 is configured with, for example, a semiconductor memory, and stores various types of information for controlling the external controller 30.

The outdoor unit control device 100 is disposed in, for example, the outdoor unit 10, and controls the compressor 11, the four-way valve 12, the outdoor fan 14, the pressure vessel 15, the liquid pipe shut-off valve 16, and the gas pipe shut-off valve 17.

The outdoor unit control device 100 includes an outdoor unit communication unit 110, an outdoor unit storage unit 120, and an outdoor unit control unit 130.

The outdoor unit communication unit 110 is a communication unit that can input communication data information and output the communication data information to the outside by communication means such as a telephone line, a LAN line, or wireless communication, for example. The outdoor unit communication unit 110 receives, for example, a cooling command (cooling ON/OFF) or a heating command (heating ON/OFF) that is output from the indoor unit control device 200, and outputs the cooling command or the heating command to the outdoor unit control unit 130. In addition, the outdoor unit communication unit 110 transmits various types of control information to the indoor unit control device 200 or the controller control device 300.

The outdoor unit storage unit 120 is configured with, for example, a semiconductor memory, and stores various types of information for controlling the outdoor unit 10. The outdoor unit storage unit 120 includes a start-up information storage unit 121.

The start-up information storage unit 121 stores start-up information indicating that a first operation check in which a normal operation (normal system start-up) is confirmed by mutual communication between the outdoor unit 10, the indoor unit 20, and the external controller 30 is completed after the air conditioning system 1 is installed. Configuration information of the system connected to the air conditioning system 1, and the like are included in the start-up information.

The outdoor unit control unit 130 is a functional unit that is implemented by causing a CPU (not shown) to execute a control program, and executes various types of processing of controlling the outdoor unit 10.

The outdoor unit control unit 130 includes an outdoor operation control unit 131 and a leakage detection processing unit 132.

The outdoor operation control unit 131 controls the compressor 11, the four-way valve 12, the outdoor fan 14, the pressure vessel 15, the liquid pipe shut-off valve 16, and the gas pipe shut-off valve 17 according to the operation command received via the outdoor unit communication unit 110.

The leakage detection processing unit 132 is an example of a countermeasure processing unit that executes the safety countermeasure processing against the leakage of the refrigerant detected by the refrigerant sensor 29. In a case where the information indicating the refrigerant leakage is received via the outdoor unit communication unit 110, the leakage detection processing unit 132 performs, as the safety countermeasure processing, for example, a control of collecting the refrigerant to the outdoor heat exchanger 13 and closing the shut-off valves (the liquid pipe shut-off valve 16 and the gas pipe shut-off valve 17) to suppress the leakage of the refrigerant to the air conditioning target space. The leakage detection processing unit 132 outputs, as the safety countermeasure processing, an alarm (warning) to the external controller 30 (the controller control device 300) via the outdoor unit communication unit 110.

In addition, in a case where abnormality has occurred in the communication with a countermeasure-related unit related to the safety countermeasure processing, the leakage detection processing unit 132 restricts the operation of the indoor unit 20 corresponding to the countermeasure-related unit in which the communication abnormality has occurred, among the plurality of indoor units 20, while maintaining the operation of the compressor 11 by the outdoor unit 10.

Here, the countermeasure-related unit is the external controller 30 (the alarm output unit 31), the indoor unit 20 (the refrigerant sensor 29), or the like. In addition, a countermeasure-related control unit that controls the countermeasure-related unit corresponds to the controller control device 300 and the indoor unit control device 200.

The leakage detection processing unit 132 determines whether or not communication abnormality has occurred between the external controller 30 and the indoor unit 20 via the outdoor unit communication unit 110. That is, the leakage detection processing unit 132 determines whether or not abnormality has occurred in the communication with the countermeasure-related unit (the external controller 30 or the indoor unit 20), based on the mutual communication between the outdoor unit control device 100, the indoor unit control device 200, and the controller control device 300 (the countermeasure-related control unit).

In addition, the leakage detection processing unit 132 executes first restriction processing of retaining the refrigerant in the outdoor unit 10 and stopping the operations of all the plurality of indoor units 20, in a case where abnormality has occurred in the communication with the countermeasure-related unit (the external controller 30 or the indoor unit 20) in a period until the first operation check is completed.

The leakage detection processing unit 132 determines any one of a period until the first operation check is completed and a period after the first operation check is completed, by confirming the information stored in the start-up information storage unit 121.

In addition, in the first restriction processing, the leakage detection processing unit 132 stops the compressor 11 and closes the shut-off valves (the liquid pipe shut-off valve 16 and the gas pipe shut-off valve 17) to suppress the leakage of the refrigerant to the air conditioning target space (the room RM1 and the room RM2).

In addition, in a case where abnormality has occurred in the communication with the countermeasure-related unit (the external controller 30 or the indoor unit 20) after the first operation check is completed, the leakage detection processing unit 132 executes second restriction processing of restricting the operation of the indoor unit 20 corresponding to the countermeasure-related unit (the external controller 30 or the indoor unit 20) in which the communication abnormality has occurred, while maintaining the operation of the compressor 11 by the outdoor unit 10.

The leakage detection processing unit 132 prohibits the operation of the indoor unit 20 corresponding to the countermeasure-related unit (the external controller 30 or the indoor unit 20) in which the communication abnormality has occurred and causes the alarm output unit 31 corresponding to the indoor unit 20 to output an alarm, in the second restriction processing. The leakage detection processing unit 132 prohibits the operation of the indoor unit 20 and causes the alarm output unit 31 of the external controller 30 to output an alarm via the outdoor unit communication unit 110. The leakage detection processing unit 132 may perform a control of stopping the operation of the pressure reduction mechanism 28, as the processing of prohibiting the operation of the indoor unit 20.

Next, the operation of the air conditioning system 1 according to the present embodiment will be described with reference to the drawings.

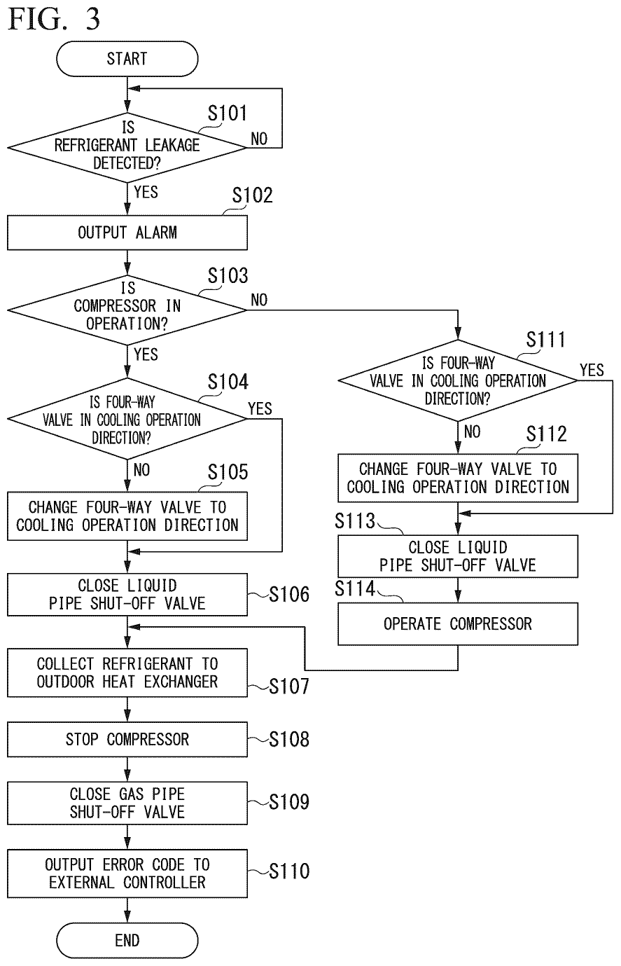

FIG. 3 is a flowchart showing an example of the safety countermeasure processing of the air conditioning system 1 according to the present embodiment.

As shown in FIG. 3, the leakage detection processing unit 132 of the outdoor unit 10 determines whether or not refrigerant leakage is detected (step S101). The leakage detection processing unit 132 determines whether or not the refrigerant leakage is detected, based on whether or not the refrigerant sensor 29 has received the detection of the refrigerant leakage from the indoor unit 20 (the indoor unit control device 200) via the outdoor unit communication unit 110. In a case where the refrigerant leakage is detected (step S101; YES), the leakage detection processing unit 132 causes the processing to proceed to step S102. In addition, in a case where the refrigerant leakage is not detected (step S101; NO), the leakage detection processing unit 132 returns the processing to step S101.

In step S102, the leakage detection processing unit 132 outputs an alarm. The leakage detection processing unit 132 causes the controller control device 300 to output an alarm (warning) from the alarm output unit 31, for example, via the outdoor unit communication unit 110.

Next, the leakage detection processing unit 132 determines whether or not the compressor 11 is in operation (step S103). In a case where the compressor 11 is in operation (step S103: YES), the leakage detection processing unit 132 causes the processing to proceed to step S104. In addition, in a case where the compressor 11 is not in operation (is being stopped) (step S103; NO), the leakage detection processing unit 132 causes the processing to proceed to step S111.

In step S104, the leakage detection processing unit 132 determines whether or not the four-way valve 12 is in the cooling operation direction (the state shown in FIG. 1). In a case where the four-way valve 12 is in the cooling operation direction (the state shown by a solid line in FIG. 1) (step S104: YES), the leakage detection processing unit 132 causes the processing to proceed to step S106. In addition, in a case where the four-way valve 12 is not in the cooling operation direction (is in the heating operation direction (the state shown by a broken line in FIG. 1)) (step S104: NO), the leakage detection processing unit 132 causes the processing to proceed to step S105.

In step S105, the leakage detection processing unit 132 changes the four-way valve 12 to the cooling operation direction (the state shown in FIG. 1). After the processing in step S105, the leakage detection processing unit 132 causes the processing to proceed to step S106.

In step S106, the leakage detection processing unit 132 closes the liquid pipe shut-off valve.

Next, in step S107, the leakage detection processing unit 132 collects the refrigerant to the outdoor heat exchanger 13. The leakage detection processing unit 132 collects a certain amount of refrigerant to the outdoor heat exchanger 13.

Next, the leakage detection processing unit 132 stops the compressor 11 (step S108).

Next, the leakage detection processing unit 132 closes the gas pipe shut-off valve 17 (Step S109).

Next, the leakage detection processing unit 132 outputs an error code to the external controller 30 (step S110). The leakage detection processing unit 132 outputs an error code to the controller control device 300 via the outdoor unit communication unit 110, for example. The remote controller control unit 340 of the controller control device 300 outputs an error code indicating refrigerant leakage to the display unit 330. After the processing in step S110, the leakage detection processing unit 132 ends the processing.

In addition, in step S111, the leakage detection processing unit 132 determines whether or not the four-way valve 12 is in the cooling operation direction (the state shown in FIG. 1). In a case where the four-way valve 12 is in the cooling operation direction (the state shown by a solid line in FIG. 1) (step S111: YES), the leakage detection processing unit 132 causes the processing to proceed to step S113. In addition, in a case where the four-way valve 12 is not in the cooling operation direction (is in the heating operation direction (the state shown by a broken line in FIG. 1)) (step S111: NO), the leakage detection processing unit 132 causes the processing to proceed to step S112.

In step S112, the leakage detection processing unit 132 changes the four-way valve 12 to the cooling operation direction (the state shown in FIG. 1). After the processing in step S112, the leakage detection processing unit 132 causes the processing to proceed to step S113,

In step S113, the leakage detection processing unit 132 closes the liquid pipe shut-off valve.

Next, the leakage detection processing unit 132 operates the compressor 11 (step S114). After the processing in step S114, the leakage detection processing unit 132 causes the processing to proceed to step S107.

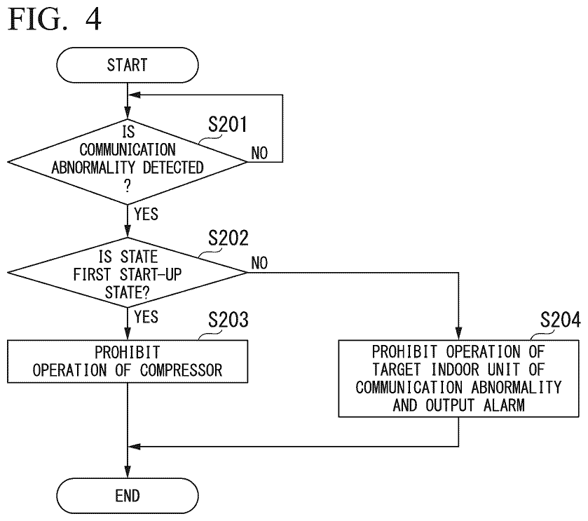

Next, the restriction processing in a case where communication abnormality has occurred will be described with reference to FIG. 4.

FIG. 4 is a flowchart showing an example of the restriction processing in a case where communication abnormality of the air conditioning system 1 according to the present embodiment occurs.

As shown in FIG. 4, the leakage detection processing unit 132 of the outdoor unit 10 determines whether or not communication abnormality has occurred (step S201). The leakage detection processing unit 132 determines whether or not abnormality has occurred in the communication with the countermeasure-related unit (the external controller 30 or the indoor unit 20), based on the mutual communication between the indoor unit control device 200 and the controller control device 300 (the countermeasure-related control unit). In a case where the communication abnormality has occurred (step S201: YES), the leakage detection processing unit 132 causes the processing to proceed to step S202. In addition, in a case where the communication abnormality has not occurred (step S201: NO), the leakage detection processing unit 132 returns the processing to step S201.

In step S202, the leakage detection processing unit 132 determines whether or not the state is a first start-up state. The leakage detection processing unit 132 determines whether or not the state is the first start-up state (a period until the first operation check is completed) by confirming the information stored in the start-up information storage unit 121. In a case where the state is the first start-up state (step S202: YES), the leakage detection processing unit 132 causes the processing to proceed to step S203. In addition, in a case where the state is not the first start-up state (step S202: NO), the leakage detection processing unit 132 causes the processing to proceed to step S204.

In step S203, the leakage detection processing unit 132 prohibits the operation of the compressor 11. The leakage detection processing unit 132 stops the operation of the compressor 11 and prohibits the entire operation of the air conditioning system 1, as the first restriction processing. The leakage detection processing unit 132 may further perform a control of closing the shut-off valves (the liquid pipe shut-off valve 16 and the gas pipe shut-off valve 17). After the processing in step S203, the leakage detection processing unit 132 ends the processing.

In step S204, the leakage detection processing unit 132 prohibits the operation of the target indoor unit 20 of the communication abnormality and outputs an alarm. The leakage detection processing unit 132 causes the indoor unit control device 200 of the target indoor unit 20 to stop the operation of the indoor unit 20 via the outdoor unit communication unit 110, and causes the controller control device 300 to output an alarm to the alarm output unit 31 via the outdoor unit communication unit 110. After the processing in step S204, the leakage detection processing unit 132 ends the processing.

In a case where communication abnormality has occurred in the indoor unit 20-1 or the external controller 30-1, the leakage detection processing unit 132 prohibits the operation of the indoor unit 20-1. However, the operation of the indoor unit 20-2 in which communication abnormality has not occurred is maintained.

As described above, the air conditioning system 1 (the air conditioner) according to the present embodiment includes the plurality of indoor units 20 (a plurality of utilization-side units), the outdoor unit 10 (a heat source-side unit), the refrigerant sensor 29, and the leakage detection processing unit 132 (a countermeasure processing unit). Each of the plurality of indoor units 20 has the indoor heat exchanger 23 (a utilization-side heat exchanger) that supplies cold heat or hot heat to the air conditioning target space (for example, the room RM1, the room RM2, or the like) by heat exchange of the refrigerant. The outdoor unit 10 includes the compressor 11 that compresses the refrigerant. The refrigerant sensor 29 detects the refrigerant that leaks into the air conditioning target space. The leakage detection processing unit 132 executes safety countermeasure processing against the leakage of the refrigerant detected by the refrigerant sensor 29. In a case where abnormality has occurred in the communication with the countermeasure-related unit (for example, the external controller 30 (the alarm output unit 31), the indoor unit 20 (the refrigerant sensor 29), or the like) related to the safety countermeasure processing, the leakage detection processing unit 132 restricts the operation of the indoor unit 20 corresponding to the countermeasure-related unit in which the communication abnormality has occurred, among the plurality of indoor units 20, while maintaining the operation of the compressor 11 by the outdoor unit 10.

In this way, in the air conditioning system 1 (the air conditioner) according to the present embodiment, the operation of the indoor unit 20 corresponding to the countermeasure-related unit in which communication abnormality has occurred is restricted, and the operation of the indoor unit 20 corresponding to the countermeasure-related unit in which communication abnormality has not occurred is maintained (permitted). Therefore, in the air conditioning system 1 according to the present embodiment, it is possible to obtain high convenience while ensuring safety.

For example, in a case where the power source of the indoor unit 20-1 is turned off and the maintenance of the indoor unit 20-1 is performed, a state in which communication with the indoor unit 20-1 is not possible occurs. In such a case, in the air conditioning system 1 according to the present embodiment, the operation of the indoor unit 20-1 is restricted, and the operation of the indoor unit 20-2 is maintained. In this way, in the air conditioning system 1 according to the present embodiment, even during a period in which the maintenance of the indoor unit 20-1 is being performed, the indoor unit 20-2 can be used, and it is possible to obtain high convenience while ensuring safety.

In addition, in the present embodiment, the plurality of indoor units 20, the outdoor unit 10, and the countermeasure-related unit including the refrigerant sensor 29 are installed, and, in a case where abnormality has occurred in communication with the countermeasure-related unit in a period (a first start-up state) until the first operation check in which a normal operation is confirmed by mutual communication is completed, the leakage detection processing unit 132 executes the first restriction processing of retaining the refrigerant in the outdoor unit 10 and stopping the operations of all the plurality of indoor units 20. In addition, in a case where abnormality has occurred in the communication with the countermeasure-related unit after the first operation check is completed, the leakage detection processing unit 132 executes the second restriction processing of restricting the operation of the indoor unit 20 corresponding to the countermeasure-related unit in which communication abnormality has occurred.

In this way, in the air conditioning system 1 according to the present embodiment, for example, in a period until the first operation check is completed, there is a high possibility that the refrigerant leaks due to defects or the like of installation and connection. Therefore, the first restriction processing of stopping all the operations of the plurality of indoor units 20 is executed from the viewpoint of ensuring safety. In addition, in the air conditioning system 1 according to the present embodiment, after the first operation check is completed, the possibility of defects of installation and connection is reduced and the possibility of refrigerant leakage due to communication abnormality is low. Therefore, the second restriction processing of restricting the operation of the indoor unit 20 corresponding to the countermeasure-related unit in which communication abnormality has occurred is executed. Therefore, in the air conditioning system 1 according to the present embodiment, it is possible to obtain high convenience while ensuring safety.

In addition, the air conditioning system 1 according to the present embodiment includes the alarm output unit 31 that outputs a warning (alarm) indicating that the refrigerant has leaked. In the second restriction processing, the leakage detection processing unit 132 prohibits the operation of the indoor unit 20 corresponding to the countermeasure-related unit in which communication abnormality has occurred and causes the alarm output unit 31 corresponding to the indoor unit 20 to output an alarm.

In this way, the air conditioning system 1 according to the present embodiment can prompt the user to ventilate the air conditioning target space or retreat from the air conditioning target space, for example, by outputting the alarm, and thus the safety in the second restriction processing can be further enhanced.

In addition, in the present embodiment, in the first restriction processing, the leakage detection processing unit 132 stops the compressor 11 and closes the shut-off valves (the liquid pipe shut-off valve 16 and the gas pipe shut-off valve 17) disposed on the refrigerant circuit that circulates the refrigerant between the outdoor unit 10 and the plurality of indoor units 20 to suppress the leakage of the refrigerant to the air conditioning target space.

In this way, the air conditioning system 1 according to the present embodiment can appropriately suppress the leakage of the refrigerant to the air conditioning target space by closing the shut-off valves (the liquid pipe shut-off valve 16 and the gas pipe shut-off valve 17), and thus, in the first restriction processing, the safety can be further enhanced.

In addition, the air conditioning system 1 according to the present embodiment includes the outdoor unit control device 100 (a heat source-side control unit), the indoor unit control device 200 (a utilization-side control unit), and the countermeasure-related control unit (for example, the controller control device 300, the indoor unit control device 200, or the like). The outdoor unit control device 100 controls the outdoor unit 10.

The indoor unit control device 200 controls the indoor unit 20. The countermeasure-related control unit (for example, the controller control device 300, the indoor unit control device 200, or the like) controls the countermeasure-related unit (for example, (the external controller 30 (the alarm output unit 31), the indoor unit 20 (the refrigerant sensor 29)). The leakage detection processing unit 132 determines whether or not abnormality has occurred in the communication with the countermeasure-related unit, based on mutual communication between the outdoor unit control device 100, the indoor unit control device 200, and the countermeasure-related control unit (the controller control device 300).

In this way, since the air conditioning system 1 according to the present embodiment determines whether or not abnormality has occurred in the communication with the countermeasure-related unit, based on the mutual communication between the respective control devices, it is possible to detect the communication abnormality with high accuracy by a simple method.

In addition, in the present embodiment, the outdoor unit control device 100 includes the leakage detection processing unit 132.

In this way, since the outdoor unit control device 100 of the outdoor unit 10, which is most likely to execute the restriction processing (the first restriction processing and the second restriction processing) against the refrigerant leakage, includes the leakage detection processing unit 132, the air conditioning system 1 according to the present embodiment can efficiently execute the restriction processing (the first restriction processing and the second restriction processing) against the refrigerant leakage.

In the present embodiment, at least one of the refrigerant sensor 29 and the alarm output unit 31 that outputs an alarm indicating that the refrigerant has leaked is included in the countermeasure-related unit.

In this way, for example, in a case where there is a concern about detection of refrigerant leakage and output of an alarm, the air conditioning system 1 according to the present embodiment executes the restriction processing (the first restriction processing and the second restriction processing), and thus it is possible to increase safety against the refrigerant leakage.

In addition, the control method according to the present embodiment is a control method of the air conditioning system 1 including the plurality of indoor units 20, the outdoor unit 10, and the refrigerant sensor 29 described above, the control method including a countermeasure processing step (a leakage detection processing step). In the countermeasure processing step (the leakage detection processing step), the leakage detection processing unit 132 executes the safety countermeasure processing against the leakage of the refrigerant detected by the refrigerant sensor 29, and in a case where abnormality has occurred in the communication with the countermeasure-related unit (for example, the external controller 30 (the alarm output unit 31)) related to the safety countermeasure processing, the leakage detection processing unit 132 restricts the operation of the indoor unit 20 corresponding to the countermeasure-related unit in which the communication abnormality has occurred, among the plurality of indoor units 20, while maintaining the operation of the compressor 11 by the outdoor unit 10.

In this way, the control method according to the present embodiment has the same effect as the air conditioning system 1 described above, and it is possible to obtain high convenience while ensuring safety.

### Second Embodiment

Next, an air conditioning system 1a according to a second embodiment will be described with reference to the drawings.

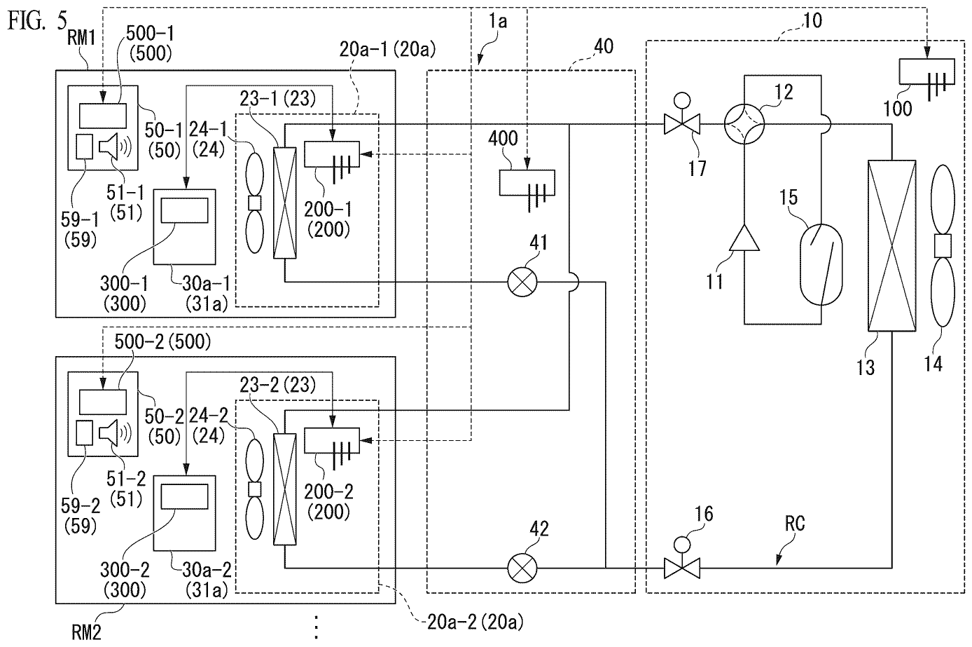

FIG. 5 is a configuration diagram showing an example of the air conditioning system 1a according to the second embodiment.

As shown in FIG. 5, the air conditioning system 1a includes the outdoor unit 10, a plurality of indoor units 20a (20a-1 and 20a-2), a plurality of external controllers 30a (30a-1 and 30a-2), a branch box 40, and a plurality of sensor alarm kits 50 (50-1 and 50-2).

In the present embodiment, the air conditioning system 1a is an example of the air conditioner.

In addition, in the present embodiment, the air conditioning system 1a is different from that of the first embodiment in that the air conditioning system 1a includes the branch box 40 and the plurality of sensor alarm kits 50 (50-1 and 50-2).

In FIG. 5, the same configurations as those shown in FIG. 1 are denoted by the same reference numerals, and the description thereof will be omitted.

In addition, in the present embodiment, the indoor unit 20a-1 and the indoor unit 20a-2 have the same configuration, and in a case where any indoor unit included in the air conditioning system 1a is indicated or not distinguished, the indoor unit 20a-1 and the indoor unit 20a-2 will be described as the indoor unit 20a.

In addition, the external controller 30a-1 and the external controller 30a-2 have the same configuration, and in a case where any external controller included in the air conditioning system 1a is indicated or not distinguished, the external controller 30a-1 and the external controller 30a-2 will be described as the external controller 30a.

In addition, the sensor alarm kit 50-1 and the sensor alarm kit 50-2 have the same configuration, and in a case where any sensor alarm kit included in the air conditioning system 1a is indicated or not distinguished, the sensor alarm kit 50-1 and the sensor alarm kit 50-2 will be described as the sensor alarm kit 50.

In addition, the outdoor unit 10, the plurality of indoor units 20a (20a-1 and 20a-2), the plurality of external controllers 30a (30a-1 and 30a-2), the branch box 40, and the plurality of sensor alarm kits 50 (50-1 and 50-2) are configured to communicate with each other.

The indoor unit 20a is the same as the indoor unit 20 of the first embodiment except that the indoor unit 20a does not include the pressure reduction mechanism 28 and the refrigerant sensor 29, and thus the description thereof will be omitted here.

The external controller 30a is the same as the external controller 30 of the first embodiment except that the external controller 30a does not include the alarm output unit 31, and thus the description thereof will be omitted here.

The branch box 40 controls the distribution of the refrigerant to each of the plurality of indoor units 20a in the refrigerant circuit RC in which the refrigerant is circulated between the outdoor unit 10 and the plurality of indoor units 20a. The branch box 40 includes a pressure reduction mechanism 41, a pressure reduction mechanism 42, and a branch box control device 400.

The pressure reduction mechanism 41 is the same as the pressure reduction mechanism 28-1 of the first embodiment, and decompresses the refrigerant with respect to the indoor unit 20a-1.

The pressure reduction mechanism 42 is the same as the pressure reduction mechanism 28-2 of the first embodiment, and decompresses the refrigerant with respect to the indoor unit 20a-2.

The branch box control device 400 is composed of, for example, a processor including a CPU, and the like, and controls the branch box 40. The branch box control device 400 is an example of the countermeasure-related control unit. The branch box control device 400 controls each part of the branch box 40 and is capable of communicating with each of the outdoor unit 10, the indoor unit 20a, the external controller 30a, and the sensor alarm kit 50. Details of the branch box control device 400 will be described later.

The sensor alarm kit 50 is an example of the countermeasure-related unit, and includes an alarm output unit 51, a refrigerant sensor 59, and a sensor alarm control device 500.

The alarm output unit 51 is the same as the alarm output unit 31 of the first embodiment, and thus, the description thereof will be omitted here. In the present embodiment, the alarm output unit 51 is included in the sensor alarm kit 50 instead of the external controller 30.

The refrigerant sensor 59 is the same as the refrigerant sensor 29 of the first embodiment, and thus, the description thereof will be omitted here. In the present embodiment, the refrigerant sensor 59 is included in the sensor alarm kit 50 instead of the indoor unit 20.

The sensor alarm control device 500 is composed of, for example, a processor including a CPU, and the like, and controls the sensor alarm kit 50. The sensor alarm control device 500 is an example of the countermeasure-related control unit. The sensor alarm control device 500 controls each part of the sensor alarm kit 50 and is capable of communicating with each of the outdoor unit 10, the indoor unit 20a, the external controller 30a, and the branch box 40. Details of the sensor alarm control device 500 will be described later.

In the present embodiment, the sensor alarm kit 50-1 is installed in the room RM1, and the sensor alarm kit 50-2 is installed in the room RM2.

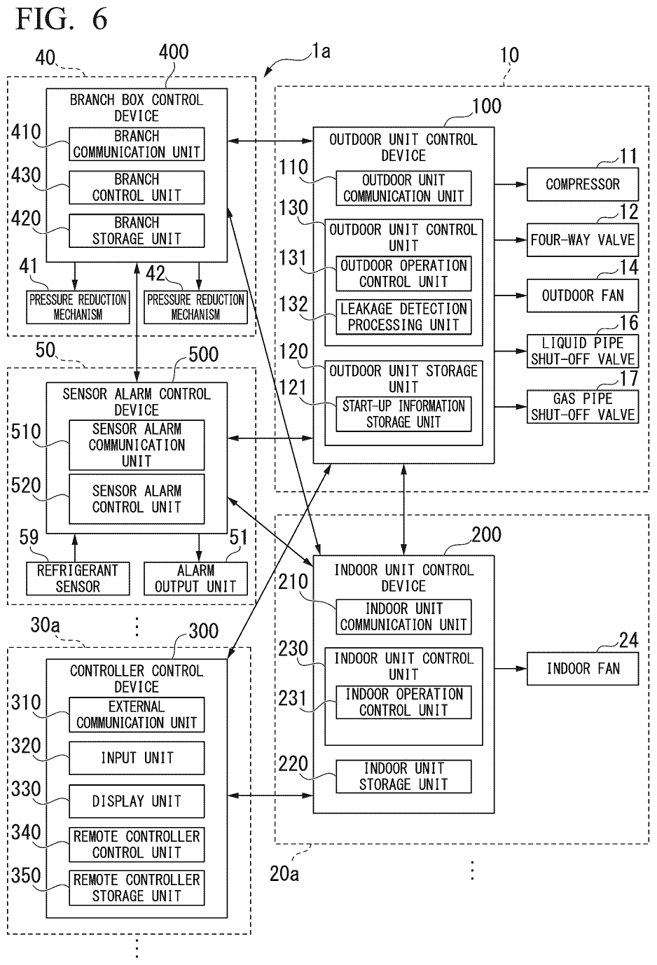

Next, a functional block of the air conditioning system 1a according to the present embodiment will be described with reference to FIG. 6.

FIG. 6 is a functional block diagram showing an example of the air conditioning system 1a according to the present embodiment.

As shown in FIG. 6, the air conditioning system 1a includes the outdoor unit control device 100, the indoor unit control device 200, the controller control device 300, the branch box control device 400, and the sensor alarm control device 500.

The outdoor unit control device 100, the indoor unit control device 200, the controller control device 300, the branch box control device 400, and the sensor alarm control device 500 are capable of notifying each other.

In FIG. 6, the same configurations as those in FIG. 2 are denoted by the same reference numerals as those in FIG. 2, and the description thereof will be omitted.

The branch box control device 400 includes a branch communication unit 410, a branch storage unit 420, and a branch control unit 430.

The branch communication unit 410 is a communication unit that can input communication data information and output the communication data information to the outside by communication means such as a telephone line, a LAN line, or wireless communication, for example.

The branch storage unit 420 is configured with, for example, a semiconductor memory, and stores various types of information for controlling the branch box 40.

The branch control unit 430 is a functional unit that is implemented by causing a CPU (not shown) to execute a control program, and executes various types of processing of controlling the branch box 40. The branch control unit 430 controls the pressure reduction mechanism 41 and the pressure reduction mechanism 42 to control the distribution of the refrigerant to each of the plurality of indoor units 20a.

The sensor alarm control device 500 includes a sensor alarm communication unit 510 and a sensor alarm control unit 520.

The sensor alarm communication unit 510 is a communication unit that can input communication data information and output the communication data information to the outside by communication means such as a telephone line, a LAN line, or wireless communication, for example.

The sensor alarm control unit 520 is a functional unit that is implemented by causing a CPU (not shown) to execute a control program, and controls the alarm output unit 51 and the refrigerant sensor 59.

In the first restriction processing, the leakage detection processing unit 132 in the present embodiment circulates the refrigerant in the outdoor unit 10 and collects the refrigerant to the outdoor heat exchanger 13 (the heat source-side heat exchanger). In the first start-up state, for example, in a case where communication abnormality has occurred between the sensor alarm kit 50 and the outdoor unit 10 or in a case where communication abnormality has occurred between the sensor alarm kit 50 and the branch box 40, the leakage detection processing unit 132 performs, as the first restriction processing, a control of collecting the refrigerant to the outdoor heat exchanger 13 (the heat source-side heat exchanger).

In addition, the leakage detection processing unit 132 in the present embodiment stops the distribution of the refrigerant to the indoor unit 20 corresponding to the countermeasure-related unit in which communication abnormality has occurred, by using the branch box 40, in a case where abnormality has occurred in the communication with the countermeasure-related unit (for example, the sensor alarm kit 50 ((the alarm output unit 51 and the refrigerant sensor 59)) related to the safety countermeasure processing.

Next, the operation of the air conditioning system 1a according to the present embodiment will be described with reference to the drawings.

Since the safety countermeasure processing of the air conditioning system 1a according to the present embodiment is the same as that in the first embodiment shown in FIG. 3, the description thereof will be omitted here.

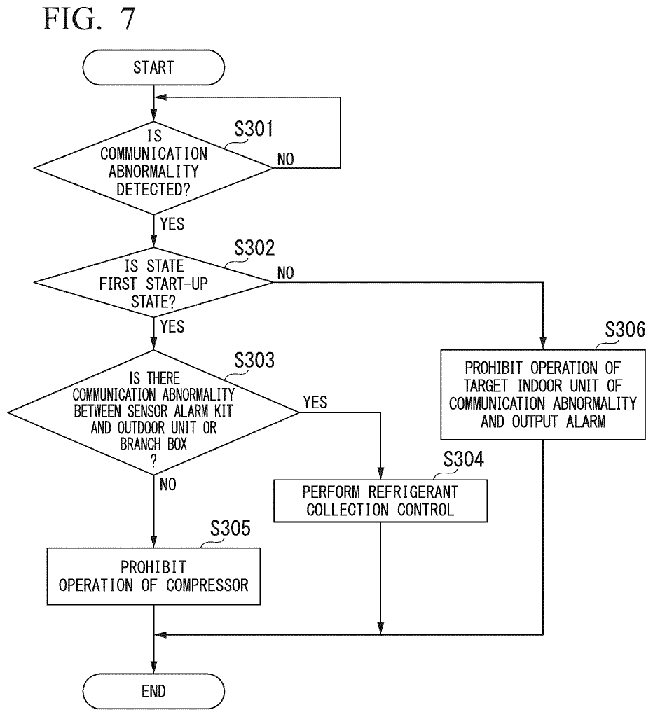

Next, the restriction processing in a case where communication abnormality has occurred in the present embodiment will be described with reference to FIG. 7.

FIG. 7 is a flowchart showing an example of the restriction processing in a case where communication abnormality of the air conditioning system 1a according to the present embodiment occurs.

As shown in FIG. 7, the leakage detection processing unit 132 of the air conditioning system 1a determines whether or not communication abnormality has occurred (step S301), The leakage detection processing unit 132 determines whether or not abnormality has occurred in the communication with the countermeasure-related unit (for example, the branch box 40, the sensor alarm kit 50, or the like), based on the mutual communication between the outdoor unit control device 100, the indoor unit control device 200, the controller control device 300, the branch box control device 400 (the countermeasure-related control unit), and the sensor alarm control device 500 (the countermeasure-related control unit). In a case where communication abnormality has occurred (step S301: YES), the leakage detection processing unit 132 causes the processing to proceed to step S302. In addition, in a case where communication abnormality has not occurred (step S301: NO), the leakage detection processing unit 132 returns the processing to step S301.

In step S302, the leakage detection processing unit 132 determines whether or not the state is the first start-up state. In a case where the state is the first start-up state (step S302: YES), the leakage detection processing unit 132 causes the processing to proceed to step S303. In addition, in a case where the state is not the first start-up state (step S302: NO), the leakage detection processing unit 132 causes the processing to proceed to step S306.

In step S303, the leakage detection processing unit 132 determines whether or not there is communication abnormality between the sensor alarm kit 50 and the outdoor unit 10 or the branch box 40. In a case where there is communication abnormality between the sensor alarm kit 50 and the outdoor unit 10 or the branch box 40 (step S303: YES), the leakage detection processing unit 132 causes the processing to proceed to step S304. In addition, in a case where there is no communication abnormality between the sensor alarm kit 50 and the outdoor unit 10 or the branch box 40 (step S303; NO), the leakage detection processing unit 132 causes the processing to proceed to step S305.

In step S304, the leakage detection processing unit 132 performs refrigerant collection control. The leakage detection processing unit 132 executes, for example, the same processing as the processing from steps S103 to S107 shown in FIG. 3 to perform the refrigerant collection control. After the processing in step S304, the leakage detection processing unit 132 ends the processing.

Since the processing in step S305 and the processing in step S306 are the same as the processing in step S203 and the processing in step S204 shown in FIG. 2 described above, the description thereof will be omitted here.

In step S306, in a case where abnormality has occurred in the communication with the countermeasure-related unit related to the safety countermeasure processing, the leakage detection processing unit 132 may stop the distribution of the refrigerant to the indoor unit 20a corresponding to the countermeasure-related unit in which communication abnormality has occurred, and prohibit the operation of the target indoor unit 20a, by using the branch box 40.

As described above, the air conditioning system 1a according to the present embodiment includes the plurality of indoor units 20a (the utilization-side units), the outdoor unit 10 (the heat source-side unit), the branch box 40, the plurality of sensor alarm kits 50, and the leakage detection processing unit 132 (the countermeasure processing unit). The sensor alarm kit 50 includes the alarm output unit 51 and the refrigerant sensor 59. The leakage detection processing unit 132 restricts the operation of the indoor unit 20a corresponding to the countermeasure-related unit in which communication abnormality has occurred, among the plurality of indoor units 20a, while maintaining the operation of the compressor 11 by the outdoor unit 10, in a case where abnormality has occurred in the communication with the countermeasure-related unit (for example, the sensor alarm kit 50 (the alarm output unit 51 and the refrigerant sensor 59) or the like) related to the safety countermeasure processing.

In this way, the air conditioning system 1a according to the present embodiment has the same effect as that in the first embodiment described above, and it is possible to obtain high convenience while ensuring safety.

In addition, in the present embodiment, the outdoor unit 10 includes the outdoor heat exchanger 13 (the heat source-side heat exchanger). In the first restriction processing, the leakage detection processing unit 132 circulates the refrigerant in the outdoor unit 10 and collects the refrigerant to the outdoor heat exchanger 13 (the heat source-side heat exchanger).

In this way, the air conditioning system 1a according to the present embodiment can appropriately suppress the leakage of the refrigerant to the air conditioning target space by collecting the refrigerant, and thus, in the first restriction processing, safety can be further enhanced.

In addition, the air conditioning system 1a according to the present embodiment includes the branch box 40 that controls the distribution of the refrigerant to each of the plurality of indoor units 20a in the refrigerant circuit RC that circulates the refrigerant between the outdoor unit 10 and the plurality of indoor units 20. The leakage detection processing unit 132 stops the distribution of the refrigerant to the indoor unit 20a corresponding to the countermeasure-related unit in which the communication abnormality has occurred, by using the branch box 40, in a case where abnormality has occurred in the communication with the countermeasure-related unit related to the safety countermeasure processing.

In this way, the air conditioning system 1a according to the present embodiment can selectively stop (prohibit) the operation of the indoor unit 20a corresponding to the countermeasure-related unit in which the communication abnormality has occurred, by using the branch box 40.

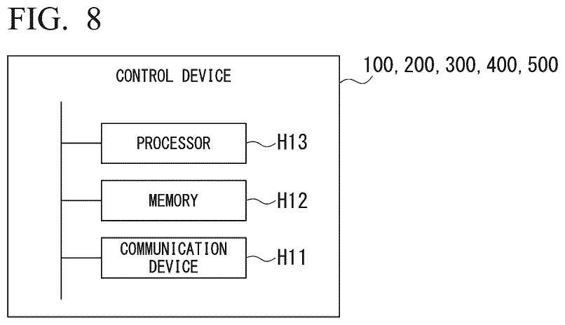

FIG. 8 is a diagram explaining a hardware configuration of each control device of the air conditioning system 1 (1a).

The device shown in FIG. 8 shows a hardware configuration of each of the control devices (the outdoor unit control device 100, the indoor unit control device 200, the controller control device 300, the branch box control device 400, and the sensor alarm control device 500) of the air conditioning system 1 (1a).

As shown in FIG. 8, each of the control devices (the outdoor unit control device 100, the indoor unit control device 200, the controller control device 300, the branch box control device 400, and the sensor alarm control device 500) of the air conditioning system 1 (1a) includes a communication device H11, a memory H12, and a processor H13.

The communication device H11 is, for example, a communication device that is connectable to a network NW1, such as a LAN card.

The memory H12 is, for example, a storage device such as a RAM, a flash memory, or an HDD, and stores various types of information and a program that are used by each of the control devices (the outdoor unit control device 100, the indoor unit control device 200, the controller control device 300, the branch box control device 400, and the sensor alarm control device 500).

The processor H13 is, for example, a processing circuit including a CPU. The processor H13 executes various types of processing of each of the control devices (the outdoor unit control device 100, the indoor unit control device 200, the controller control device 300, the branch box control device 400, and the sensor alarm control device 500) by executing the program stored in the memory H12.

The controller control device 300 further includes an input device corresponding to the input unit 320 and a display device corresponding to the display unit 330 in the hardware configuration shown in FIG. 8.

In addition, the present disclosure is not limited to the present embodiments described above and can be modified within a scope which does not depart from the gist of the present disclosure.

For example, in each of the embodiments described above, the example in which the shut-off valves (the liquid pipe shut-off valve 16 and the gas pipe shut-off valve 17) are included in the outdoor unit 10 has been described. However, there is no limitation thereto, and the shut-off valves (the liquid pipe shut-off valve 16 and the gas pipe shut-off valve 17) may be disposed outside the outdoor unit 10. The shut-off valves (the liquid pipe shut-off valve 16 and the gas pipe shut-off valve 17) may be disposed at other positions of the refrigerant circuit RC.

In addition, in each of the embodiments described above, the example in which the outdoor unit 10 includes the leakage detection processing unit 132 has been described. However, there is no limitation thereto, and the leakage detection processing unit 132 may be included outside the outdoor unit 10 or in another device (for example, the indoor unit 20 (20a), the branch box 40, or the like). In addition, the function of the leakage detection processing unit 132 may be included in a distributed manner in a plurality of devices.

In addition, in each of the embodiments described above, the example in which the indoor unit 20 (20a), the external controller 30 (30a), and the sensor alarm kit 50 are two by two has been described. However, there is no limitation thereto, and the air conditioning system 1 (1a) may include three or more of these devices.

Each configuration of the air conditioning system 1 (1a) described above includes a computer system inside. Then, a program for realizing the functions of each configuration of the air conditioning system 1 (1a) described above may be recorded on a computer-readable recording medium, and the program recorded on the recording medium may be read into the computer system and executed to perform the processing in each configuration of the air conditioning system 1 (1a). Here, the expression “the program recorded on the recording medium is read into the computer system and executed” includes installing the program in the computer system. Here, the term “computer system” as referred to herein includes OS and hardware such as a peripheral device.

In addition, the term “computer system” may include a plurality of computer devices connected via a network including a communication line such as the Internet, a WAN, a LAN, or a dedicated line. Also, the term “computer-readable recording medium” refers to a portable medium, such as a flexible disk, a magneto-optical disk, a ROM, or a CD-ROM, and a storage device, such as a hard disk incorporated in the computer system. As described above, the recording medium on which the program is stored may be a non-transitory recording medium such as a CD-ROM.

In addition, the recording medium also includes an internal or external recording medium that is accessible by a distribution server for distributing the program. The program may be divided into a plurality of parts, each of which may be downloaded at different times and then combined in each component of the air conditioning system 1 (1a), or each divided part of the program may be distributed by a different distribution server. Further, the term “computer-readable recording medium” also includes a medium that stores the program for a certain time, such as a volatile memory (RAM) inside the computer system that serves as a server or a client in a case where the program is transmitted via a network. In addition, the above-described program may be a program for implementing some of the above-described functions. Furthermore, the program may be a so-called difference file (difference program) capable of implementing the functions described above in combination with a program that has already been recorded on the computer system.

### REFERENCE SIGNS LIST

1, 1a Air conditioning system
10 Outdoor unit
11 Compressor
12 Four-way valve
13 Outdoor heat exchanger
14 Outdoor fan
15 Pressure vessel
16 Liquid pipe shut-off valve
17 Gas pipe shut-off valve
20, 20-1, 20-2, 20a, 20a-1, 20a-2 Indoor unit
23, 23-1, 23-2 Indoor heat exchanger
24, 24-1, 24-2 Indoor fan
28, 28-1, 28-2, 41, 42 Pressure reduction mechanism
29, 29-1, 29-2, 59, 59-1, 59-2 Refrigerant sensor
30, 30-1, 30-2, 30a, 30a-1, 30a-2 External controller
31, 31-1, 31-2, 51, 51-1, 51-2 Alarm output unit
40 Branch box
50, 50-1, 50-2 Sensor alarm kit
100 Outdoor unit control device
110 Outdoor unit communication unit
120 Outdoor unit storage unit
121 Start-up information storage unit
130 Outdoor unit control unit
131 Outdoor operation control unit
132 Leakage detection processing unit
200, 200-1, 200-2 Indoor unit control device
210 Indoor unit communication unit
220 Indoor unit storage unit
230 Indoor unit control unit
231 Indoor operation control unit
300, 300-1, 300-2 Controller control device
310 External communication unit
320 Input unit
330 Display unit
340 Remote controller control unit
350 Remote controller storage unit
400 Branch box control device
410 Branch communication unit
420 Branch storage unit
430 Branch control unit
500 Sensor alarm control device
510 Sensor alarm communication unit
520 Sensor alarm control unit
RC Refrigerant circuit
RM1, RM2 Room

1. An air conditioner comprising:
a plurality of utilization-side units each having a utilization-side heat exchanger configured to supply cold heat or hot heat to an air conditioning target space by heat exchange of a refrigerant;
a heat source-side unit including a compressor configured to compress the refrigerant;
a refrigerant sensor configured to detect the refrigerant that has leaked into the air conditioning target space; and
a processor configured to execute safety countermeasure processing against leakage of the refrigerant detected by the refrigerant sensor and, in a case where abnormality has occurred in communication with a countermeasure-related unit related to the safety countermeasure processing, configured to restrict an operation of a utilization-side unit corresponding to the countermeasure-related unit in which communication abnormality has occurred, among the plurality of utilization-side units, while maintaining an operation of the compressor by the heat source-side unit.

2. The air conditioner according to claim 1,
wherein the processor is configured to:
execute first restriction processing of retaining the refrigerant in the heat source-side unit and stopping operations of all the plurality of utilization-side units, in a case where the plurality of utilization-side units, the heat source-side unit, and the countermeasure-related unit including the refrigerant sensor are installed and abnormality has occurred in communication with the countermeasure-related unit in a period until a first operation check in which normal operation is confirmed by mutual communication is completed; and
execute, in a case where abnormality has occurred in the communication with the countermeasure-related unit after the first operation check is completed, second restriction processing of restricting an operation of the utilization-side unit corresponding to the countermeasure-related unit in which the communication abnormality has occurred.

3. The air conditioner according to claim 2, further comprising an alarm output unit configured to output an alarm indicating that the refrigerant has leaked,
wherein the processor is configured to prohibit the operation of the utilization-side unit corresponding to the countermeasure-related unit in which the communication abnormality has occurred, and cause the alarm output unit corresponding to the utilization-side unit to output the alarm, in the second restriction processing.

4. The air conditioner according to claim 2,
wherein the processor is configured to stop the compressor and close a shut-off valve disposed on a refrigerant circuit that circulates the refrigerant between the heat source-side unit and the plurality of utilization-side units, to suppress leakage of the refrigerant into the air conditioning target space, in the first restriction processing.

5. The air conditioner according to claim 2,
wherein the heat source-side unit includes a heat source-side heat exchanger, and
the processor is configured to circulate the refrigerant in the heat source-side unit and collect the refrigerant to the heat source-side heat exchanger, in the first restriction processing.

6. The air conditioner according to claim 1, further comprising a branch box configured to control distribution of the refrigerant to each of the plurality of utilization-side units in a refrigerant circuit that circulates the refrigerant between the heat source-side unit and the plurality of utilization-side units,
wherein, in a case where abnormality has occurred in communication with the countermeasure-related unit related to the safety countermeasure processing, the processor is configured to stop the distribution of the refrigerant to the utilization-side unit corresponding to the countermeasure-related unit in which the communication abnormality has occurred, by using the branch box.

7. The air conditioner according to claim 1, further comprising:
a heat source-side controller configured to control the heat source-side unit;
a utilization-side controller configured to control the utilization-side unit; and
a countermeasure-related controller configured to control the countermeasure-related unit,
wherein the processor is configured to determine whether or not abnormality has occurred in communication with the countermeasure-related unit, based on mutual communication between the heat source-side controller, the utilization-side controller, and the countermeasure-related controller.

8. The air conditioner according to claim 7,
wherein the heat source-side controller includes the processor.

9. The air conditioner according to claim 1,
wherein at least one of the refrigerant sensor and an alarm output unit configured to output an alarm indicating that the refrigerant has leaked is included in the countermeasure-related unit.

10. A control method of an air conditioner including a plurality of utilization-side units each having a utilization-side heat exchanger configured to supply cold heat or hot heat to an air conditioning target space by heat exchange of a refrigerant, a heat source-side unit including a compressor configured to compress the refrigerant, and a refrigerant sensor configured to detect the refrigerant that has leaked into the air conditioning target space, the control method comprising:
executing, by using a processor, safety countermeasure processing against leakage of the refrigerant detected by the refrigerant sensor; and
in a case where abnormality has occurred in communication with a countermeasure-related unit related to the safety countermeasure processing, restricting, by using the processor, an operation of a utilization-side unit corresponding to the countermeasure-related unit in which communication abnormality has occurred, among the plurality of utilization-side units, while maintaining an operation of the compressor by the heat source-side unit.
